(19) United States
(12) Patent Application Publication
(10) Pub. No.: US 2007/0134979 A1
(43) Pub. Date: Jun. 14, 2007

(54) Connecting structure for lamp

(76) Inventor: Teng-Li Chen, Hui-Yang City (CN)

Correspondence Address: HDSL, 4331 STEVENS BATTLE LANE, FAIRFAX, VA, 22033, US

(21) Appl. No.: 11/302,277

(22) Filed: Dec. 14, 2005

(51) Int. Cl. H01R 9/05

(52) U.S. Cl. 439/578

(57) ABSTRACT

A connecting structure for a lamp, which can be used to combine a lamp holder, a lamppost or a lamp base, includes a first body and a second body interconnected with the first body. Conductive connectors are correspondingly provided on connecting ends of the first body and the second body, respectively. Each conductive contactor has a first contacting terminal and a second contacting terminal peripherally provided on the circumference of the first contacting terminal, such that each conductive terminal can be electrically communicated with each other during the assembling of the first body and the second body. With this arrangement, the present invention can simplify the whole structure of the lamp, save the volume of load and greatly reduce the material and cost in conveyance.

### BACKGROUND OF THE INVENTION

1. Field of the Invention

The present invention relates to an improved connecting structure for a lamp. In particular, the present invention relates to a connecting structure for the combination of a lamp holder, a lamppost or a lamp base.

2. Description of Prior Art

Lamps have been widely used in daily life since they were invented. With regard to medium or large lamps such as floor lamps or ceiling lamps, those lamps have bulkier volume than other lamps, and thus occupy very large space in conveyance. Therefore, each of the main elements of such kinds of larger lamps is adapted to be detachable to reduce the volume of load and the cost in conveyance. Since the elements are designed to be detachable, it is necessary for the customers to assemble those elements together, such that an assembled lamp can be obtained. For this reason, it is an important issue for those skilled in this art to simplify the lamp structure and reduce the volume of load.

A conventional connecting structure for a lamp, as disclosed in Taiwan Patent Publication No. 515506, mainly includes a lamp base, a lamppost, a fixing sleeve and an inserting sleeve, wherein a plurality of fixing holes are provided on the lamp base. The fixing hole is used for inserting the fixing sleeve and fixed by a positioning nut. The inserting sleeve is provided within the fixing sleeve. Inner threads are provided within the inserting sleeve for locking and connecting an end of the lamppost. A plug is provided on the bottom of the inserting sleeve for connecting to a socket in the lamp base. Finally, a fixing nut is fixed on the fixing sleeve and thus applies a force on the lamp base. As a result, a connecting structure for a lamp is completely assembled.

Although the conventional connecting structure for a lamp can advantageously reduce the volume of load, the structure comprises multiple elements such as the fixing sleeve the inserting sleeve, the fixing nut and the positioning nut, such that the whole structure is very complicated. Moreover, the materials, production cost and burden in stock increase greatly, thereby to lose the practicability and the economical benefits. Further, since the construction is complicated, the customers should try to assemble all elements together, which will influence the purchasing will of the customer and increase the inconvenience in use.

In view of the above drawbacks, the inventor employs his experience in this art and contemplates to provide a feasible design to efficiently improve the above drawbacks.

### SUMMARY OF THE INVENTION

The present invention is to provide an improved connecting structure for a lamp, which is capable of simplifying the whole structure of the lamp, saving the volume of load, and greatly reducing the materials and cost in conveyance.

Accordingly, the present invention provides an improved connecting structure for a lamp, which can be used to combine a lamp holder, a lamppost or a lamp base. The present invention comprises a first body and a second body interconnected with the first body. Conductive connectors are correspondingly provided on connecting ends of the first body and the second body, respectively. Each conductive contactor has a first contacting terminal and a second contacting terminal peripherally provided on the circumference of the first contacting terminal, such that each conductive terminal can be electrically communicated with each other during the assembling of the first body and the second body.

### BRIEF DESCRIPTION OF DRAWING

FIG. 1 is an assembled view showing a floor lamp to which the present invention is applied;

FIG. 2 is a partially exploded and perspective view showing a lamp holder and a lamppost of FIG. 1;

FIG. 3 is a partially assembled and cross-sectional view showing the lamp holder and the lamppost of FIG. 1;

FIG. 4 is a perspective view showing the external appearance of the lamppost of the present invention; and

FIG. 5 is a cross-sectional view showing the lamppost of the present invention.

### DETAILED DESCRIPTION OF THE INVENTION

The detail description and technical contents of the present invention will be explained with reference to the accompanying drawings. However, it should be noted that the drawings are used to illustrate but not to limit the scope of the present invention.

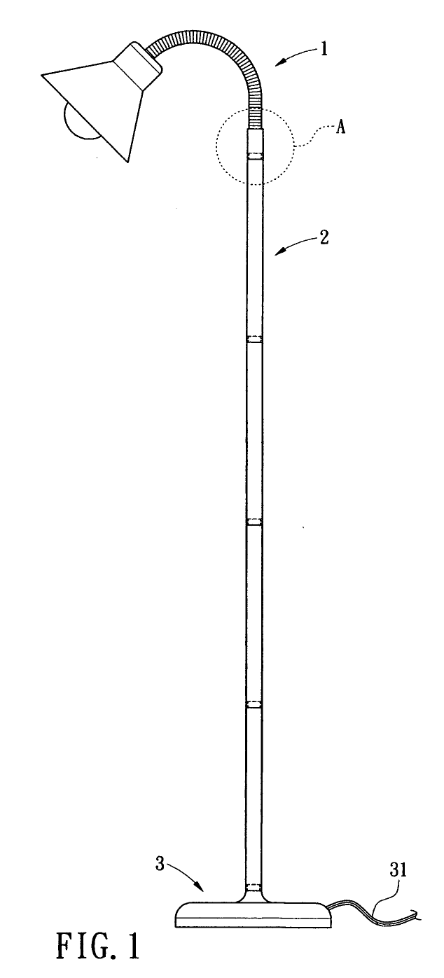

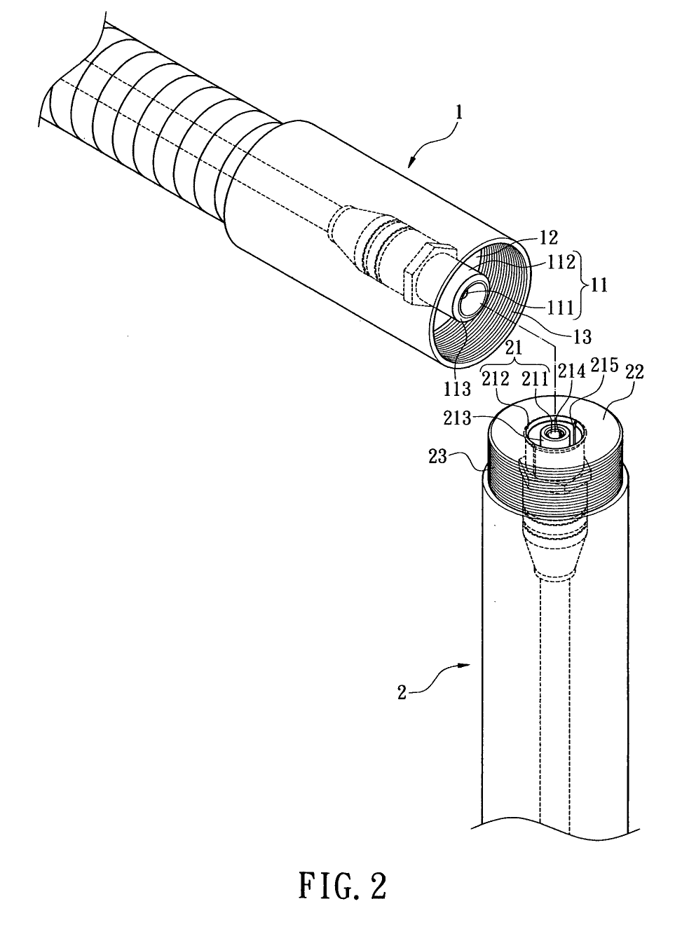

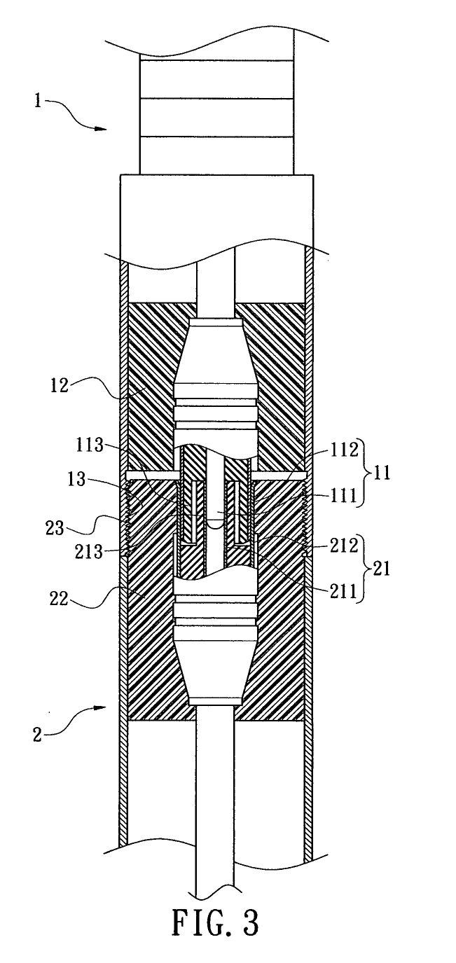

With reference to FIGS. 1, 2 and 3, FIG. 1 is an assembled view showing a floor lamp to which the present invention is applied. FIG. 2 is a partially exploded and perspective view showing a lamp holder and a lamppost of FIG. 1. FIG. 3 is a partially assembled and cross-sectional view showing the lamp holder and the lamppost of FIG. 1. The present invention provides an improved connecting structure for a lamp, which can be used to combine a lamp holder, a lamppost or a lamp base, thereby to further ontain a medium or larger lamp such as a floor lamp or a ceiling lamp. The present invention comprises a first body 1 and a second body 2 interconnected with the first body 1. The first body 1 can be a lamp holder, a lamppost or a lamp base. In the present embodiment, the first body is shown as a lamp holder. The second body 2 can be either a lamppost or a lamp base connected to the above lamp holder, or can be an integral combination of the lamppost and the lamp base. In the present embodiment, the second body is shown as a lamppost. In addition, the present invention comprises a third body 3 when it is applied to a floor lamp. The third body 3 correspondingly connects to the bottom end of the second body 2. In the present embodiment, the third body is shown as a lamp base. The lamp base is provided with a power line 31 at one side of the circumference thereof.

The connecting structure of the present invention can be provided on the lamp holder, the lamppost or the lamp base. Further, the ways and constructions of combining are substantially the same. For clarity, with respect to FIG. 2, conductive conductors 11, 21 are correspondingly provided on the bottom end of the first body 1 and the top end of the second body 2, respectively. An insulating element 12 is provided between the conductive contactor 11 and the first body 1, while an insulating element 22 is provided between the conductive contactor 21 and the second body 2. Those insulating elements can be made of plastic materials. The insulating element 12 is provided within the first body 1. Inner threads 13 are provided on the inner wall of the first body 1 and outside of the insulating element 12. The insulating element 22 is projected from the second body 2 and provided with external threads 23 for locking with the inner threads 13.

Further, the conductive contactors 11, 21 can be a cable connector. The conductive contactor 11(21) has a first contacting terminal 111(211) and a second contacting terminal 112(212) peripherally provided on the circumference of the first contacting terminal 111(211). An insulating layer 113 is provided between the first contacting terminal 111 of the conductive contactor 11 and the inner circumference of the second contacting terminal 112. Similarly, an insulating layer 213 is provided between the outer circumference of the first contacting terminal 211 of the conductive contactor 21 and the second contacting terminals 112, 212. The conductive contactor 11 provided in the first body 1 is a male terminal, whereas the conductive contactor 21 provided in the second body 2 is a female terminal for receiving the above male terminal. The peripheral walls of the first contacting terminal 211 and the second contacting terminal 212 of the female conductive conductor 21 are correspondingly provided with slots 214 and 215, respectively.

The conductive contactor 11 of the first body 1 rotatably combines with the conductive contactor 21 of the second body 2, such that the inner threads of the first body 1 can be screwed on the external threads 23 of the second body 2. Further, since the first contacting terminal 111 and the second contacting terminal 112 of the conductive contactor 11 correspondingly contact with the first contacting terminal 211 and the second contacting terminal 212 of the other conductive contactor 21, respectively, a conductive loop can be formed.

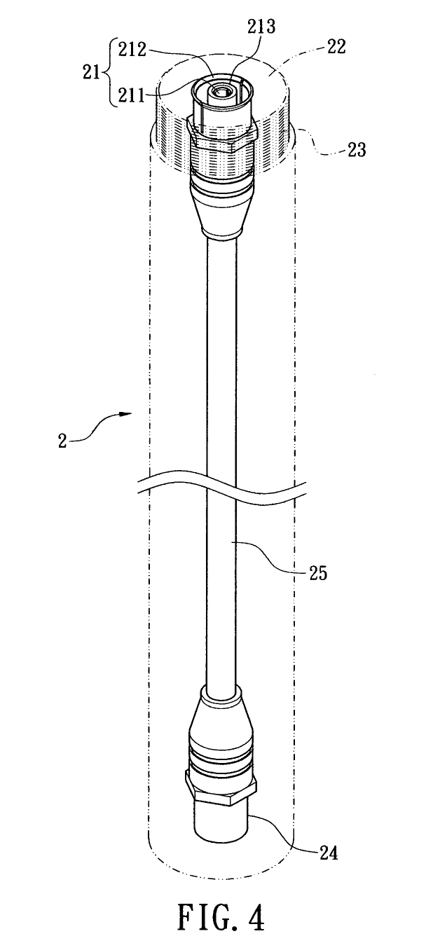

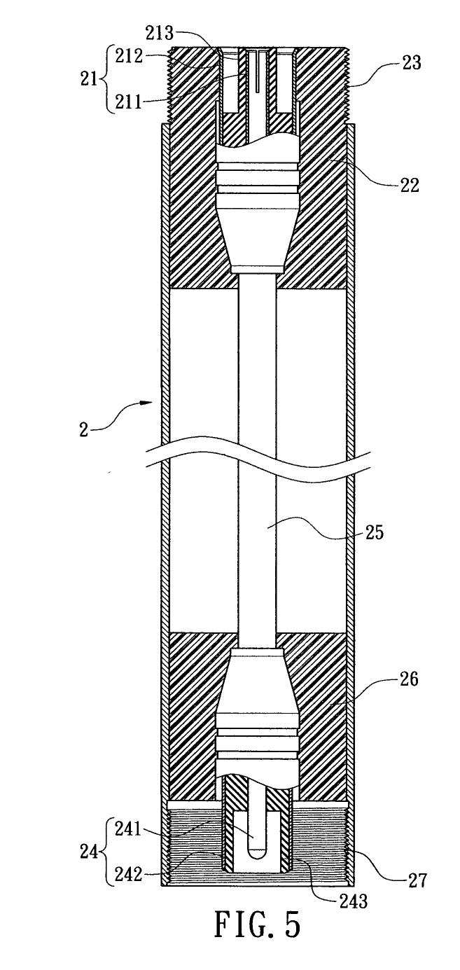

As shown in the above embodiment, the connecting structure of the present invention can be applied to the connection between the lamp holder and the lamppost. In additional, it can also be applied to the connection between the lamppost and the lamp base, and further can be applied to the connection between multiple lampposts. With reference to FIGS. 4 and 5, FIG. 4 is a perspective view showing the external appearance of the lamppost of the present invention. The lamppost 2 of the present embodiment has a tube body. A conductive contactor 21 and the other conductive contactor 24 are provided on the upper and lower ends of the tube body, respectively. A lead 25 is connected between the conductive contactor 21 and the other conductive contactor 24. The other conductive contactor 24 also has a first contacting terminal 241 and a second contacting terminal 242. An insulating layer 243 is provided between the first contacting terminal 241 and the inner circumference of the second contacting terminal 242. An insulating element 26 is provided with the other conductive contactor 24 and the tube body. Inner threads 27 are provided in the inner wall of the tube body outside the insulating element 26. With the above arrangements, multiple lampposts 2 can be rotatably assembled together, thereby to obtain a floor lamp formed of multiple lampposts (as shown in FIG. 1).

According to the improved connecting structure of the present invention, the problem of twisting in leads occurred in conventional lamp connecting structures can be efficiently solved. Further, the present invention can simplify the whole lamp structure, save the volume of load, and greatly reduce the materials and cost in conveyance.

According to the above, the present invention can solve the drawbacks of prior art and achieve the expected purposes. Further, the present invention has not been published or put to public prior to applying for patent, and thus indeed involves novelty and inventive steps to conform to the requirements for a patent.

Although the present invention has been described with reference to the foregoing preferred embodiment, it will be understood that the invention is not limited to the details thereof. Various equivalent variations and modifications can still be occurred to those skilled in this art in view of the teachings of the present invention. Thus, all such variations and equivalent modifications are also embraced within the scope of the invention as defined in the appended claims.

What is claimed is:

1. A connecting structure for a lamp, comprising a first body and a second body interconnected with the first body, wherein conductive contactors are provided on the connecting ends of the first body and the second body, respectively, each conductive contactor has a first contacting terminal and a second contacting terminal peripherally provided on the circumference of the first contacting terminal, such that each conductive terminal can be electrically communicated with each other during the assembling of the first body and the second body.

2. The connecting structure for a lamp according to claim 1, wherein the first body is a lamp holder.

3. The connecting structure for a lamp according to claim 2, wherein the second body is either a lamppost or a lamp base connected to the lamp holder, or the combination of the lamppost and the lamp base.

4. The connecting structure for a lamp according to claim 1, wherein the conductive contactor is a cable contactor.

5. The connecting structure for a lamp according to claim 1, wherein insulating elements are provided between each conductive contactor and the first body and the second body, respectively.

6. The connecting structure for a lamp according to claim 5, wherein the insulating element is provided within the first body, inner threads are provided on the inner wall of the first body outside the insulating element, the insulating element provided in the second body is projected from the outside of the second body to form external threads for locking with the inner threads.

7. The connecting structure for a lamp according to claim 6, wherein the conductive contactor of the first body is a male terminal, while the conductive contactor of the second body is a female terminal for receiving the male terminal.

8. The connecting structure for a lamp according to claim 7, wherein the peripheral walls of the first contacting terminal and the second contacting terminal of the female conductive contactor are provided with corresponding slots.

9. The connecting structure for a lamp according to claim 1, an insulating layer is provided between the first contacting terminal and the second contacting terminal of the conductive contactor.

10. The connecting structure for a lamp according to claim 1, wherein the first body is connected to the second body by rotatably assembling.

11. The connecting structure for a lamp according to claim 1, wherein the second body has a tube body, conductive contactors provided on upper and lower ends of the tube body, and a lead provided between each conductive contactor.

12. The connecting structure for a lamp according to claim 1, further comprising a third body connected to the bottom of the second body and connected with a power line.

13. The connecting structure for a lamp according to claim 12, wherein the third body is a lamp base.
